(19) United States
(12) Patent Application Publication
(10) Pub. No.: US 2010/0117795 A1
(43) Pub. Date: May 13, 2010

(54) INFORMATION TERMINAL

(76) Inventors: Masaaki Satou, Gunma (JP); Naoto Matsumoto, Gunma (JP); Junichi Nishio, Saitama (JP); Takahiro Ohtsuki, Gunma (JP)

Correspondence Address: BANNER & WITCOFF, LTD., 1100 13th STREET, N.W., SUITE 1200, WASHINGTON, DC, 20005-4051, US

(21) Appl. No.: 11/997,971

(22) PCT Filed: Jul. 18, 2006
(86) PCT No.: PCT/JP2006/314165

§ 371 Date: Feb. 5, 2008

(30) Foreign Application Priority Data
Aug. 18, 2005 (JP) 2005-237477

(51) Int. Cl. H04Q 5/22; H04M 1/00

(52) U.S. Cl. 340/10.1; 455/558

(57) ABSTRACT

An information terminal wherein a simple operation can provide appropriate contents. An information terminal (1), which provides, based on externally inputted information, predetermined contents, comprises a storage part (12) that stores a plurality of contents; a communication part (22) that receives predetermined information from an external IC chip (A); a display part (21) that displays the contents stored in the storage part (12); and a control part (11) that selects, based on the received information of the IC chip (A) received by the communication part (22), a content stored in the storage part (12), and then causes the display part (21) to display the selected content.

### TECHNICAL FIELD

The present invention relates to an information terminal, such as installed in a convenience store and provides contents based on information inputted from a non-contact type IC equipped mobile telephone.

### BACKGROUND ART

Conventionally, information terminals of this type are installed in the inside of a store, and provide a user of the store with contents corresponding to a request of the user through operations on a keyboard, touch panel or the like.

In this case, vested contents corresponding to the request are provided without differentiating among users, and thus appropriate contents are not necessarily provided.

To solve this problem, there has been known an information terminal which accesses the server of a service provider via a network, receives contents produced by the server based on information which the user has inputted via the information terminal, and provides the contents requested by the user (for example, refer to Patent Document 1).

According to the conventional information terminal, however, the user must input the user ID and information on requested contents by use of a keyboard, touch panel or the like; thus as the number of contents increases and also the preference of users varies widely, the input operation may become cumbersome or complicated.

### Patent Document 1: Japanese Patent Publication No. 2003-108696

### DISCLOSURE OF THE INVENTION

### Problems to be Solved by the Invention

The present invention has been accomplished in view of the above problems and has an object to provide an information terminal which can provide appropriate contents with a simple operation.

### Means for Solving the Problems

In order to achieve the above object, the present invention proposes an information terminal which provides contents based on information inputted from the outside, the information terminal including: a storage unit which stores a plurality of contents; a communication unit which receives predetermined information from an external IC chip; a display unit which displays the contents in the storage unit; and a control unit which selects from among the contents of the storage unit based on the information received via the communication unit from the IC chip and causes the display unit to display the contents.

According to the present invention, the predetermined information in an IC chip is received solely by bringing close to the communication unit, for example, a non-contact type IC equipped mobile telephone, so that contents based on the predetermined information in the IC chip are displayed on the display unit.

### ADVANTAGES OF THE INVENTION

According to the present invention, the predetermined information stored in an IC chip is received solely by bringing close to the communication unit, for example, a non-contact type IC equipped mobile telephone, so that contents based on the predetermined information stored in the IC chip are displayed on the display unit. Thus contents can be selected and displayed on the display unit based on, for example, user identification information or the number of reception times; appropriate contents can be provided with a simple operation.

The above object and other objects, features and advantages of the present invention will become evident with reference to the following descriptions and accompanying drawings.

### BRIEF DESCRIPTION OF THE DRAWINGS

FIG. 1 is an external perspective view of an information terminal according to a first embodiment of the present invention;

FIG. 2 is a block diagram illustrating a control system configuration of the information terminal;

FIG. 3 is a view illustrating a database configuration of the storage unit illustrated in FIG. 2;

FIG. 4 is a flowchart illustrating the operation of the information terminal;

FIG. 5 is a flowchart illustrating the operation of an information terminal according to a variation of the first embodiment; and

FIG. 6 is a flowchart illustrating the operation of an information terminal according to a second embodiment of the present invention.

### DESCRIPTION OF SYMBOLS

1 . . . Information terminal, 2 . . . Non-contact type IC equipped mobile telephone, 11 . . . Control unit, 12 . . . Storage unit, 21 . . . Display unit, 22 . . . Communication unit, A . . . IC chip.

### BEST MODE FOR CARRYING OUT THE INVENTION

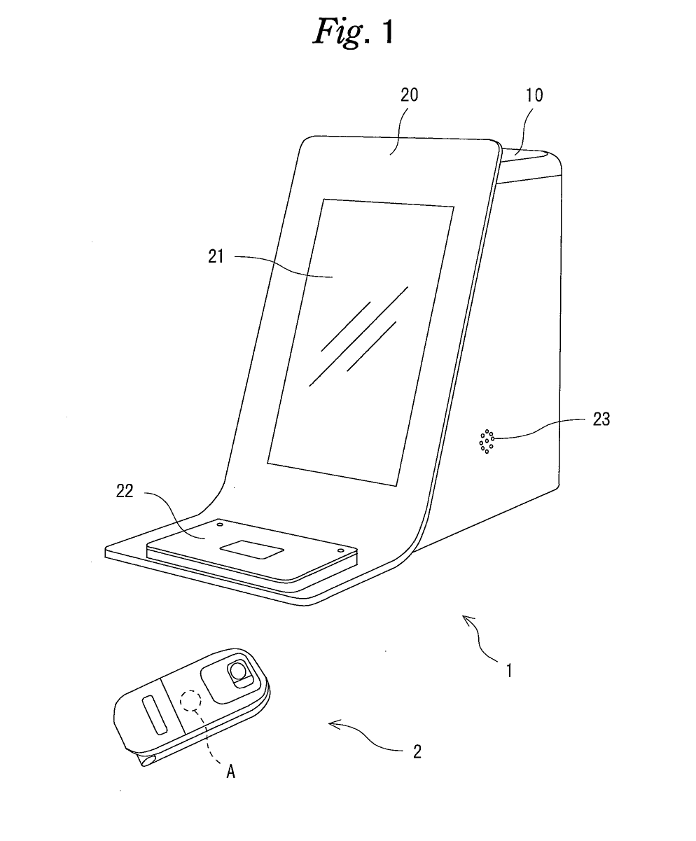

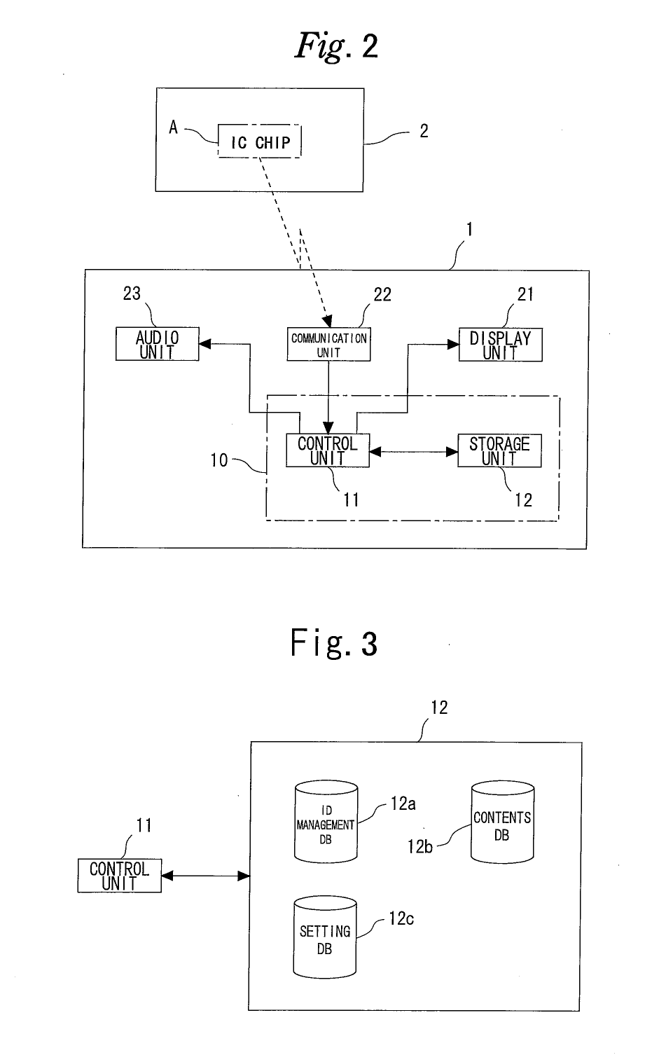

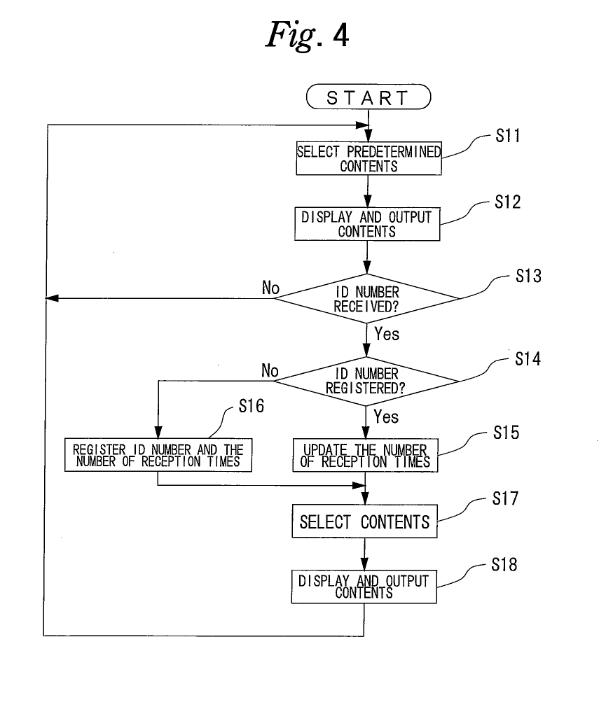

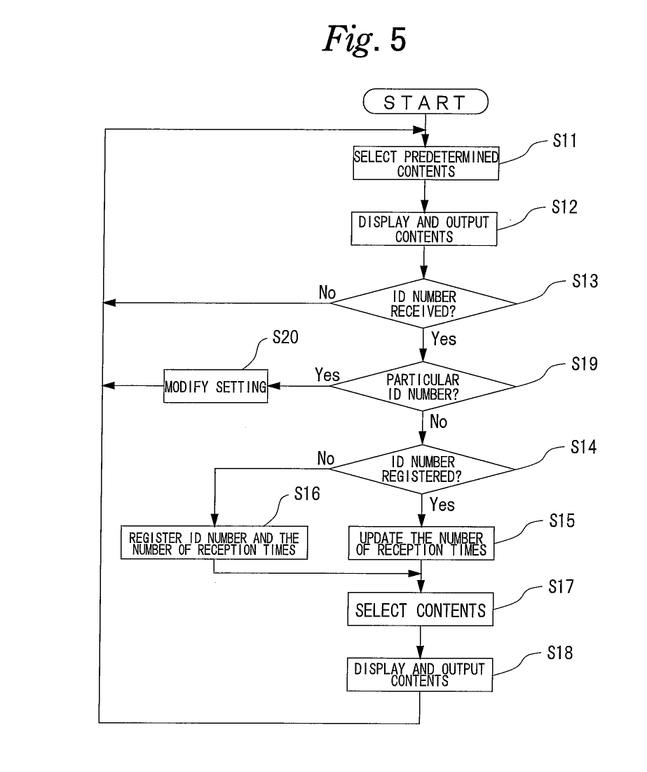

FIGS. 1 to 4 illustrate a first embodiment of the present invention. FIG. 1 is an external perspective view of an information terminal according to the first embodiment of the present invention; FIG. 2 is a block diagram illustrating a control system configuration of the information terminal; FIG. 3 is a view illustrating a database configuration of the storage unit illustrated in FIG. 2; FIG. 4 is a flowchart illustrating the operation of the information terminal; FIG. 5 is a flowchart illustrating the operation of an information terminal according to a variation of the first embodiment.

As illustrated in FIG. 1, an information terminal 1 according to the present embodiment is a kiosk terminal known as a small-sized information terminal installed in the inside of a store, and constituted of a terminal main body 10 and a front panel 20.

The front panel 20 is arranged on the front face of the terminal main body 10; and a display is arranged as a display unit 21 at the center of the front panel 20.

The display unit 21 is for displaying video contents represented by still images, moving images, characters, figures, symbols or the like, and arranged in the inside of the front panel 20 so that its display surface is exposed to the outside. In this case, the display unit 21 may be a liquid crystal display, for example, or a known CRT (Cathode Ray Tube) display, PDP (Plasma Display Panel), organic EL (Electro Luminescence) display or like which can display contents.

An IC chip reader is arranged as a communication unit 22 below the front panel 20 which has a curved-forward surface.

The communication unit 22 is, for example, for performing communication via an antenna (not illustrated) by radio wave with IC chip A of a non-contact type IC equipped mobile telephone 2 which lies in a communicatable range, and thereby receiving predetermined data stored in a memory of IC chip A. Accordingly, data in IC chip A can be received solely by bringing close to the communication unit 22, the non-contact type IC equipped mobile telephone 2. In this case, the reception object is not limited to the non-contact type IC equipped mobile telephone 2, but may be an IC card or the like. An IC chip reader/writer may be provided as the communication unit 22 to allow the information terminal 1 to transmit the result of communicating with IC chip A and cause it to be stored in the memory of IC chip A.

Unless described otherwise, there will be described below a case where predetermined data is received from the non-contact type IC equipped mobile telephone 2.

Loudspeakers are arranged as an audio unit 23 on both surfaces of the terminal main body 10.

The audio unit 23 is for outputting audio contents represented by sounds, voices or the like. To achieve stereophonic effects by a stereo system, multichannel system or the like, two or more loudspeakers are preferably provided, but a single loudspeaker may be sufficient.

The terminal main body 10 includes, as illustrated in FIG. 2, a control unit 11 and a storage unit 12.

The control unit 11 is for selecting from among contents stored in the storage unit 12 based on data received via the communication unit 22 from IC chip A of the non-contact type IC equipped mobile telephone 2 and then causing the display unit 21 to display the video contents and/or causing the audio unit 23 to output the audio contents. The control unit 11 is constituted of a known computer containing CPU, RAM, ROM and the like, and connected to the storage unit 12, the display unit 21, the communication unit 22 and the audio unit 23.

The storage unit 12 is for storing multiple video and/or audio contents to be displayed on the display unit 21 and/or outputted to the audio unit 23, and is constituted of a known large-capacity storage apparatus such as a hard disk apparatus, magnetic tape apparatus or optical disk apparatus or the like, and may be arranged in the inside or outside of the terminal body 10. The storage unit 12 may be an EEPROM (Electrically Erasable and Programmable ROM) such as flash memory or the like depending on the amount of stored contents, or may be a storage apparatus, such as a network drive apparatus or the like, connected via a network.

The storage unit 12 is as illustrated in FIG. 3, constituted of an ID management database (hereinafter referred to as a DB) 12a, contents DB 12b and setting DB 12c.

Registered in the ID management DB 12a are data including: unique ID numbers for each IC chip A previously received via the communication unit 22; and a history of the number of reception times and the reception dates of each ID number; and the like. Preliminarily registered in the contents DB 12b are component data of video or audio contents such as games, commercials, music, or sound effects or the like. Registered in the setting DB 12c are setting data for each contents component, such as game winning odds, character type, and/or commercial background and the like; this setting data and the contents component data registered in the contents DB 12b are combined to provide contents.

In this case, video contents or audio contents may be provided, or a combination of video and audio contents may be provided. Further, each DB may be any type of database, such as relational, network or hierarchical type or the like, or may be not a DB, but a mere file used to store and/or file a large amount of data. The configuration and number of DBs are not limited to the above three DBs, but a single or two or three or more DBs may be appropriately designed.

As illustrated in FIG. 4, when the information terminal 1 starts up, in order to provide preliminarily set predetermined contents, e.g., a commercial, the control unit 11 activates the program for contents selection to combine contents component data and setting data from the storage unit 12 and thereby select predetermined contents (S11). In this case, the number of the predetermined contents does not need to be preliminarily set to one, but the program for contents selection may make random selection from among multiple preliminarily set contents, or make selection according to the date or time. The control unit 11 causes the display unit 21 to display the selected contents and if necessary, also outputs them to the audio unit 23 (S12).

Subsequently, the control unit 11 determines based on mutual authentication between the communication unit 22 and non-contact type IC equipped mobile telephone 2, whether or not the communication unit 22 has received ID number data from IC chip A (S13). Alternatively, it may be determined whether or not predetermined data containing ID number data has been received.

If it is determined that ID number data has not been received from IC chip A of the non-contact type IC equipped mobile telephone 2, steps S11 to S13 are repeated until ID number data is received.

On the other hand, if it is determined that ID number data has been received from IC chip A of the non-contact type IC equipped mobile telephone 2, the control unit 11 determines whether or not the received ID number data has been registered in the ID management DB 12a (S14). If it is determined that the received ID number data has been registered in the ID management DB 12a, a predetermined value (for example, “1”) is added to data on the number of reception times of the received ID number data, registered in the ID management DB 12a to update the data (S15). If the received ID number data has not been registered, the received ID number and data on the number of reception times (for example, the number of reception times=“1”) are registered without executing step S15 (S16).

Subsequently, the control unit 11 selects contents by causing the program for contents selection to combine, according to the received ID number and data on the number of reception times, contents component data registered in the contents DB 12b and setting data registered in the setting DB 12c (S17). Accordingly, there can be selected contents which are, for example, of a different type, such as bingo or roulette or the like, dependent on the non-contact type IC equipped mobile telephone 2, and which have a different setting such as winning odds increased according to the number of reception times.

The control unit 11 causes the display unit 21 to display the selected contents and if necessary, also outputs the selected contents to the audio unit 23 (S18). Then, after displaying and outputting the contents for a predetermined length of time, the control unit 11 repeats steps S11 to S18 until the information terminal 1 stops.

In this way, with the information terminal 1 of the present embodiment, the ID number of IC chip A is received solely by bringing the non-contact type IC chip equipped mobile telephone 2 close to the communication unit 22, so that contents based on the received ID number of IC chip A and on the number of times of reception from IC chip A are displayed on the display unit 21. Thus, contents dependent on the ID number and the number of reception times can be selected and displayed on the display unit 21; that is, appropriate contents can be provided with a simple operation.

According to the present embodiment, contents are selected based on the ID number of IC chip A and the number of times of reception from that IC chip A; however, contents may be selected based on the ID number of IC chip A and the date of reception from that IC chip A, or predetermined data received from that IC chip A.

Alternatively, contents may be selected solely based on the ID number of IC chip A. In this case, there can be selected contents based on the user's age, sex and/or profession and the like specified by the ID number of IC chip A.

As illustrated in FIG. 5, when ID number data is received from IC chip A of the non-contact type IC equipped mobile telephone 2 after step S13, before performing step S14, it is determined whether or not the ID number received by the control unit 11 is particular ID number data for modifying the program for contents selection (S19). In performing this determination, particular ID number flag is provided in the ID management DB 12a to preliminarily register a particular ID.

If the ID number data received from IC chip A of the non-contact type IC equipped mobile telephone 2 is not the particular ID number data, S14 and subsequent steps are executed. On the other hand, if the ID number data received from IC chip A of the non-contact type IC equipped mobile telephone 2 is the particular ID number data, the setting of the program for contents selection is modified (S20), and then step S11 and the steps thereafter is executed again. Accordingly, after the setting modification, timely contents selection is possible, such as provision of predetermined special contents, e.g., commercial selection according to climate conditions at step S11 and the like, or selection of a bingo having odds increased according to the number of reception times or according to the number of reception times during a limited period at step S17, or the like; thus, more appropriate contents can be provided.

The information terminal 1 is preferably provided with an interface such as USB (Universal Serial Bus), whereby contents component data and/or setting data are updated, registered and/or deleted, if necessary, from the outside, or the program for contents selection is modified.

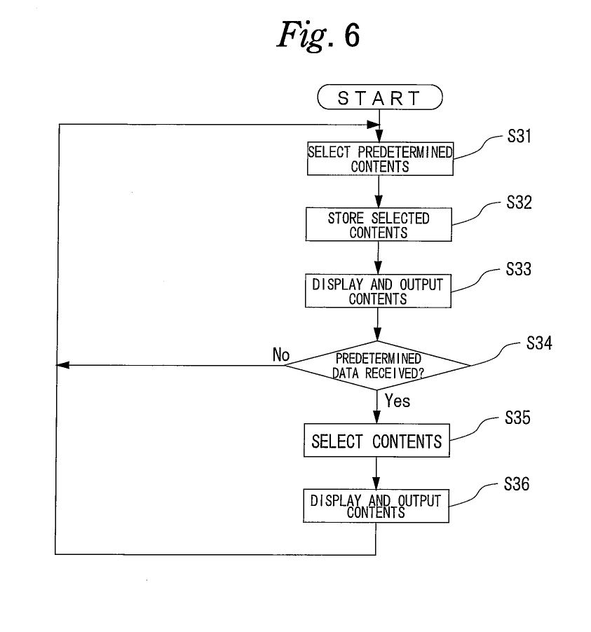

FIG. 6 illustrates a second embodiment of the present invention and is a flowchart illustrating the operation of an information terminal. In FIG. 6, the same reference characters are applied to constituent parts corresponding to the first embodiment, and an explanation thereof is omitted.

According to the second embodiment, when the information terminal 1 starts up, in order to provide preliminarily set predetermined contents, the control unit 11 activates the program for contents selection to combine contents component data and setting data from the storage unit 12 and thereby select from among multiple predetermined contents (S31), and stores the selected contents into RAM or the storage unit 12 (S32). Similarly to the first embodiment, the program for contents selection may make random selection from among multiple preliminarily set contents, or make selection according to the date or time. The control unit 11 causes the display unit 21 to display the selected contents and if necessary, also outputs them to the audio unit 23 (S33).

Subsequently, the control unit 11 determines based on mutual authentication between the communication unit 22 and non-contact type IC equipped mobile telephone 2, whether or not the communication unit 22 has received predetermined data from IC chip A (S34). In this case, the predetermined data is data stored in the memory of IC chip A and may or may not contain ID number data.

If predetermined data has not been received from IC chip A of the non-contact type IC equipped mobile telephone 2, steps S31 to S34 are repeated until predetermined data is received.

If predetermined data has been received from IC chip A of the non-contact type IC equipped mobile telephone 2, the control unit 11 causes the program for contents selection to combine, based on the received predetermined data and the contents stored in step S32, contents component data registered in the contents DB 12b and setting data registered in the setting DB 12c and thereby make contents selection (S35).

The control unit 11 causes the display unit 21 to display the selected contents and if necessary, also outputs them to the audio unit 23 (S36). Then, after displaying and/or outputting the contents for a predetermined length of time, the control unit 11 repeats steps S31 to S36 until the information terminal 1 stops.

In this way, with the information terminal 1 according to the present embodiment, for example, based on data on the purchased amount and/or points and the like at the store received from IC chip A of the non-contact type IC equipped mobile telephone 2 and the commercial most recently displayed on the display unit 21, discount information or coupon information related to the displayed commercial can be provided according to the purchased amount, the points or the like. Thus, similarly to the first embodiment, appropriate and timely contents can be provided with a simple operation.

In this case, while discount information or coupon information are displayed on the display unit 21, the communication unit 22 preferably transmits via an IC chip reader/writer the discount information or coupon information to the non-contact type IC equipped mobile telephone 2, so that they are stored in the memory of IC chip A.

The information terminal may be constructed by combining the configurations and operations of the above described embodiments or replacing part of the configurations and operations.

Further, the configuration and operation of the present invention are not limited to the above described embodiments, but many changes or modifications to the embodiments are possible without departing from the gist of the invention.

### INDUSTRIAL APPLICABILITY

The present invention is applicable to an information terminal which selects from among contents stored in a storage unit based on information received via a communication unit from an IC chip and causes a display unit to display the contents, and thus can select contents dependent on the identification information of the user or the number of reception times or the like and display them on the display unit; that is, the information terminal is installed in the inside of a store such as a convenience store or the like and provides contents based on information inputted from a non-contact type IC equipped mobile telephone.

1. An information terminal which provides contents based on information inputted from the outside, comprising:
a storage unit which stores a plurality of contents;
a communication unit which receives predetermined information from an external IC chip;
a display unit which displays contents in storage unit; and
a control unit which selects from among the contents in storage unit based on information received via the communication unit from IC chip and causes display unit to display the contents.

2. The information terminal according to claim 1, wherein: the communication unit receives unique identification information from the external IC chip; and the control unit selects contents dependent on identification information.

3. The information terminal according to claim 2, wherein the control unit selects contents dependent on the identification information received via the communication unit from IC chip and on the number of reception times of identification information.

4. The information terminal according to claim 1, wherein after a predetermined length of time has elapsed since the display unit displayed contents, the control unit selects predetermined contents until the communication unit receives predetermined information from the external IC chip.

5. The information terminal according to claim 4, wherein the control unit selects from among contents in the storage unit based on the predetermined contents and reception via the communication unit from the external IC chip.

6. The information terminal according to claim 1, wherein the communication unit receives predetermined information from an IC chip arranged in a user's mobile telephone.
